(19) United States
(12) Patent Application Publication
(10) Pub. No.: US 2001/0021931 A1
(43) Pub. Date: Sep. 13, 2001

(54) Organising information

(76) Inventor: Ian John Vaughan, Thorpe Bay (GB)

Correspondence Address: Paul D. Greeley, Esq., Ohlandt, Greeley, Ruggiero & Perle, L.L.P., One Landmark Square, 10th Floor, Stamford, CT, 06901-2682, US

(21) Appl. No.: 09/803,423

(22) Filed: Mar. 9, 2001

(30) Foreign Application Priority Data
Mar. 13, 2000 (GB) 0006045.9
Apr. 14, 2000 (GB) 0009384.9

(51) Int. Cl. G06F 7/00; G06F 17/30

(52) U.S. Cl. 707/100; 707/1

(57) ABSTRACT

A system and method for organising information items in a database. The system and method use a three-dimensional classification space having a co-ordinate origin, which in a preferred embodiment may be displayed as a rotatable sphere 20. Subject topics are associated in the classification space with solid cones 22 having radii 21 of the sphere as their axes and information items are assigned co-ordinates 24 within the appropriate subject cone. The sphere may be further divided into shells 11,12,13 of different radii corresponding to different categories of information items within the same subject area. In retrieving information it is possible to display items of information assigned similar co-ordinates within the classification space and to rotate the sphere to show neighboring items having associated subject content. The invention has particular application to classifying and search for web sites or other information on the Internet.

### BACKGROUND OF THE INVENTION

1. Field of the Invention

This invention relates to a method and system for organising information. The invention has particular application in the retrieval of information from the Internet or World Wide Web.

2. Related Art

Indexing schemes and classification schemes for organising information are well known as a means of improving the speed of retrieving information from information sources. Such schemes have been traditionally used in libraries and on-line databases with reasonable success. However, application of known techniques to retrieving information from the Internet has resulted in considerable inefficiency in the relevance of items retrieved, in the completeness or success of the retrieval and in the speed of retrieval.

The part of the Internet known as the World Wide Web is by far the most rapidly evolving information and communications medium in the world. Within ten years the Web grew from a few pages of text into a network of over one billion web pages, documents and files. Annually many more people have gained access to the Internet and the volume of data posted on the Web has increased significantly.

Web pages are stored on servers throughout the world and each web page is registered with a unique Uniform Resource Locator (URL) to identify the web site. These URLs typically reflect an organisation's name, geographical location and type of business, e.g. Freeserve.co.uk. The URL can be one of a number of domain types, including top-level domain types, for example, .com for commercial sites, .gov for governmental sites and .ac for academic sites. Apart from the top-level domain types the URL's usually have a country identifier at the end of the domain name. Internet Name Servers store tables of these URLs and the unique Internet Protocol (IP) numbers or addresses of the corresponding servers. Therefore, to retrieve information from the internet, web browsers (i.e. programs on, for example, Personal Computers (PCs)) connect to the correct web pages via the Name Servers, which convert the URL to an IP address, and via routers which pass packet information containing the information address until they reach the host server and then collect data packets which are sent back to the requesting web browser on the PC.

At present, it is possible to find and retrieve data from the web in several different ways.

If a web site name (URL) is known to a user, the user may access the web site directly by typing in the name of the web site in the web browser.

At a given web site there are often provided links to further sites so that it is possible to “surf” to other related pages of interest. In this way it is, in principle, possible to browse across pages of interest on the web. However, this method is reliant upon authors of web sites inserting and updating related links on their pages and removing out-of-date or redundant links.

As the web grew, there emerged a special series of web sites designed to be used as public tools for finding items of interest on the Internet. These are known as search engines. The search engines function in a number of different ways to index or classify web sites, so that on conducting a search a list of “hits” may be obtained which match the search criteria. These sites may rely solely on keyword searching or may use some level of classification, often in conjunction with keyword searching. For example, an Internet search engine may provide a three-level hierarchy of subjects from broad subjects to narrow or related subjects and permit keyword searching within each of the upper levels of the hierarchy. Thus, levels of the hierarchy may be Science, Physics, and Atomic Physics or, in another example, Music, Pop Music, and Downloadable MP3 Files, where the lowest level of the hierarchy would return the user a list of web sites offering downloadable music in MP3 format.

Other search engines merely allow keyword searching of a large database of information about web sites.

These search engines actively collect information about web sites on the Internet. This information is usually collected and updated by computer programs known as web-crawlers which browse the web, following links, and catalogue or index, in the search engine database, information about the sites that they visit. The data stored in the databases ranges from search engine to search engine. Some search engines index every (significant) word of the text on the web sites they visit. Others index only the title or the hundred keywords most frequently used within the web site.

As well as limiting a keyword search by subject, it is sometimes possible to limit searches to a particular country with which the web sites are associated.

As the Internet grows and evolves, millions of new web pages are added monthly. Each of these new pages is assigned a unique URL to reflect its content. Ideally these URLs would make it very easy to find, for example, a particular company's web site. In practice, however, there are so many slightly different variations of URL possible, and competition for them is so fierce, that it is not always possible to find the desired web site simply by knowing the name of a company and guessing the URL. This has meant that the dependence on search engines has grown with the growth of Internet.

However, the present generation of search engines are organised in such a way that as the Internet has grown, there is too much data to handle and it becomes increasingly difficult to conduct a fast and effective search to find specific information. Increasingly, simple Internet searches return hundreds, if not thousands, of “hits”. However, the majority of these “hits” are not relevant to the person conducting the search and must be scanned to find any sites of interest.

Moreover, it is not possible with present search engines to visualise the information database making up the World Wide Web, nor to navigate through related items.

Search engines using keywords also suffer all the traditional problems of keyword searches, including uncontrolled vocabularies and ambiguities. In addition, web authors may simply want as many people as possible to visit their site and therefore provide a description of the content of their web sites containing very many common words, but which do not truly reflect the content of the site. This means that the web site will appear as a “hit” as a result of a search, whereas the content of the site is completely irrelevant to the search.

Search engines that adopt a classification-driven structure of topic lists also present problems. This type of hierarchical classification results in a splitting of information between topics, but there is no way to link information that overlaps between classifications. For example, information that is related and has definite overlaps has to be placed into separate classifications and so may be separated by several levels of hierarchy. This again frustrates a user trying to find all relevant information on a subject. The combination of a hierarchical classification with a keyword system may at present provide the best method of searching for web sites. However, as the Internet and Web continue to grow, the ability quickly and accurately to search for information is being eroded. This is a reflection of the lack of any underlying structure to the Web. Although search engines may be developed having more logic-driven search strategies, with the large quantity of information available the difficulty remains that the Web is impossible to index satisfactorily because it contains no definite form. Frustration with finding information on the Internet will become detrimental to the development of the Web unless a fundamental structural change occurs.

### SUMMARY OF THE INVENTION

It is an object of the present invention to organise information items in such a manner that searches may be carried out with greater efficiency.

According to a first aspect of the present invention, there is provided an organising system for organising information items in a database, the information items having information content within a subject area; the system comprising: geometric means for providing a three dimensional classification space having a co-ordinate origin and providing signals representative thereof to display means whereby the classification space is displayable as a three dimensional rotatable object; input means for associating information items with co-ordinates in the three dimensional classification space; navigating means for searching for information items in the three dimensional classification space; and output means for retrieving at least one of said information items from the three dimensional classification space.

Preferably the three dimensional classification space is a spherical polar coordinate classification space and the rotatable object is a rotatable sphere.

Preferably the geometric means includes locating means for associating predetermined subject areas with respective ranges of angles of azimuth and declination relative to the spherical co-ordinate origin to form subject radial pillars.

Advantageously, where the information items are further associated with respective information categories, the geometric means further comprises categorising means for associating pre-determined information categories with respective ranges of radial distances from the co-ordinate origin to form spherical category shells.

Conveniently, the locating means is adapted for allocating predetermined subject topics within a subject radial pillar to respective spaced apart co-ordinates on a shell to form subject pegs.

More conveniently, the locating means is further adapted for allocating predetermined subject sub-topics to respective co-ordinates in the vicinity of a related subject peg to form subject sub-pegs.

Advantageously, the geometric means further comprises indexing means for updating a classification index with the polar co-ordinate ranges or locations of subject areas, subject categories, subject topics and/or subject sub-topics.

Preferably, the locating means is adapted for allocating an information item according to the subject area of the information item to a corresponding subject radial pillar and assigning polar co-ordinates in the vicinity of the subject radial pillar to the information item.

Advantageously, the locating means is further adapted for assigning the information item to a category shell according to the information category of the information item.

More advantageously, the locating means is further adapted for allocating the information item according to the subject topic of the information item with polar coordinates in the vicinity of the polar co-ordinates of a subject peg corresponding to that subject topic.

Conveniently, the locating means is further adapted for allocating information items according to the subject sub-topic of the information item with polar co-ordinates in the vicinity of the polar co-ordinates of a sub-peg corresponding to that subject subtopic.

Preferably, the navigating means is adapted for selecting a subject radial pillar corresponding to the subject area of an information item searched for, preferably by performing a look-up in the classification index, and further comprises rotating means for rotating the sphere as necessary to display contents in the vicinity of the selected subject radial pillar.

Advantageously, the navigation means comprises shell display means for displaying within the selected subject radial pillar a search shell having associated search means for performing a search within the subject radial pillar for information items within a required subject category and subject topic, and for displaying a portion of a shell, corresponding to the subject category, containing information items corresponding to the subject topic of the information item searched for in the vicinity of a peg corresponding to the subject topic of the information item searched for.

Conveniently, the shell display means is adapted for displaying a portion of a shell in the vicinity of a sub-peg containing information items corresponding to the sub-topic of the information item searched for.

Advantageously, the search means is adapted to search in the classification index for topics and/or sub-topics having associated pegs and sub-pegs respectively.

Advantageously, the input means is adapted for indexing geographical information associated with the information item and the navigating means is adapted for using geographical information as a search criterion.

Conveniently, the input means is adapted for storing a value or range of latitude or longitude associated with the information item and the navigating means is adapted for searching for information items by their associated stored values or ranges of latitude and longitude.

Preferably, the navigating means includes geographical display means for displaying a globe of the world or a map and the navigating means is adapted for selecting on the display of the globe or map the geographical location associated with information items searched for.

According to a second aspect of the present invention there is provided a method for organising information items in a database, the information items having information content within a subject area; the method comprising the steps of:

a) providing geometric means to provide a three dimensional classification space having a co-ordinate origin; b) using the geometric means to provide signals representative of the classification space to display means whereby the classification space is displayed as a rotatable three dimensional object; c) providing and using input means to associate information items with co-ordinates in the three dimensional classification space; d) providing and using navigating means to search for information items in the classification space; and e) providing and using output means to retrieve at least one of said information items from the classification space.

Preferably step a) includes providing a spherical polar co-ordinate classification space as the three dimensional classification space and step b) includes displaying a rotatable sphere as the rotable three dimensional object.

Preferably, step a) includes using locating means to associate pre-determined subject areas with respective ranges of angles of azimuth and declination relative to the spherical co-ordinate origin to form subject radial pillars.

Advantageously, where the information items are further associated with respective information categories, step a) includes using categorising means to associate predetermined information categories with respective ranges of radial distances from the co-ordinate origin to form spherical category shells.

Conveniently, step a) includes using the locating means to allocate predetermined subject topics within a subject radial pillar to respective spaced apart coordinates on a shell to form subject pegs.

Preferably step a) includes allocating, using the locating means, predetermined subject sub-topics to respective co-ordinates in the vicinity of a related subject peg to form subject sub-pegs.

Advantageously, step a) includes updating a classification index with the polar co-ordinate ranges or locations of subject areas, subject categories, subject topics and/or subject sub-topics.

Preferably, step c) includes using the locating means to allocate an information item, according to the subject area of the information item, to a corresponding subject radial pillar and assigning polar co-ordinates within the subject radial pillar to the information item.

Advantageously, step c) further includes using the locating means to assign the information item to a category shell, according to the information category of the information item.

More advantageously, step c) further includes using the locating means to allocate the information item, according to the subject topic of the information item, polar co-ordinates in the vicinity of the polar co-ordinates of a peg corresponding to that subject topic.

Conveniently, step c) further includes using the locating means to allocate the information item, according to the subject sub-topic of the information item, polar coordinates in the vicinity of the polar co-ordinates of a sub-peg corresponding to that subject sub-topic.

Preferably, step d) further includes using the navigating means to select a subject radial pillar, corresponding to the subject area of an information item searched for, preferably by performing a look-up in the classification index, and further includes rotating the sphere as necessary to display contents in the vicinity of the selected subject radial pillar.

Conveniently, step d) further includes using shell display means to display, within the selected subject radial pillar, a search shell having associated search means; performing a search within the subject radial pillar for information items within a required subject category and subject topic; and displaying a portion of a shell, corresponding to the subject category, containing information items corresponding to the subject topic of the information item searched for in the vicinity of a peg corresponding to the subject topic of the information item searched for.

Advantageously, step d) includes using the shell display means to display a portion of a shell in the vicinity of a sub-peg containing information items corresponding to the sub-topic of the information item searched for.

Advantageously, step d) includes using the search means to search in the classification index for topics and/or sub-topics having associated pegs and sub-pegs respectively.

Advantageously, step c) includes using the input means to index geographical information associated with the information item and step d) includes using geographical information as a search criterion.

Conveniently, step c) includes using the input means to store a value or range of latitude and longitude associated with the information item and step d) includes using the navigating means to search for information items by their associated stored values or ranges of latitude and longitude.

According to a third aspect of the invention, there is provided an input device for use in the above method, the input device having means for generating a signal for rotating the rotatable sphere.

Conveniently, the signal generating means is a tracker ball.

Preferably, the input device also includes selection means for selecting an information category.

Advantageously, the input device further includes cursor control means and switching means for switching the input device between navigation operations according to the present invention and cursor control operations.

According to a fourth aspect of the invention, there is provided a computer program comprising program code means for performing all the steps of the above method when the program is run on a computer.

Conveniently, the computer program is embodied on a computer-readable medium.

According to a fifth aspect of the invention, there is provided a computer program product comprising program code means stored in a computer-readable medium for performing the above method when that program product is run on a computer.

The invention provides the advantage of visualisation of a classification of information items, in particular web-pages, or web-page addresses, and facilitates browsing between related subject topics by grouping related information items together.

Although the invention is described herein in relation to indexing web sites on the Internet, it will be apparent that the invention is by no means limited to such applications. The invention can be used to classify any collection of data or information items, particularly where they may be classified under a large number of classifications or categories. Thus the method and system can be used to create a virtual 3D library, a CD or music catalogue. The invention can also be used as a user-friendly front end for any large database or store of information. For example, the invention can be used to index an individual web site to facilitate navigation around that individual web site.

### BRIEF DESCRIPTION OF THE DRAWINGS

The invention will now be discussed by way of example with reference to the accompanying drawings, in which:

FIG. 1 shows polar co-ordinates usable in the present invention;

FIG. 1A shows shells usable in the present invention, based on the polar co-ordinates of FIG. 1;

FIG. 2 depicts a rotatable classification sphere display of the present invention;

FIG. 2A shows the rotatable sphere of FIG. 2, with a subject cone used in the invention;

FIG. 2B shows the subject cone of FIG. 2A, with subject pegs and sub-pegs used in the invention;

FIG. 3 shows a distribution of subjects to radial pillars of the sphere of FIG. 2;

FIG. 4 shows a window of a browser program using the invention;

FIG. 4A shows a perspective view of an input device for use with the browser window of FIG. 4;

FIG. 5 shows a flowchart of the method of setting up the classification of the present invention;

FIG. 6 shows a flowchart of the method of adding an information item to the classification sphere of the invention;

FIG. 7 shows a flowchart of a user's actions in retrieving an information item from the classification sphere of the invention;

FIG. 8 shows processing steps carried out by the system of the invention when a user retrieves an information item as shown in FIG. 7;

FIG. 9 shows a flowchart of a means of assigning advertisements to the classification sphere; and

FIG. 10 shows a flowchart of a means of displaying advertisements.

In the Figures like reference numerals denote like parts.

### DETAILED DESCRIPTION

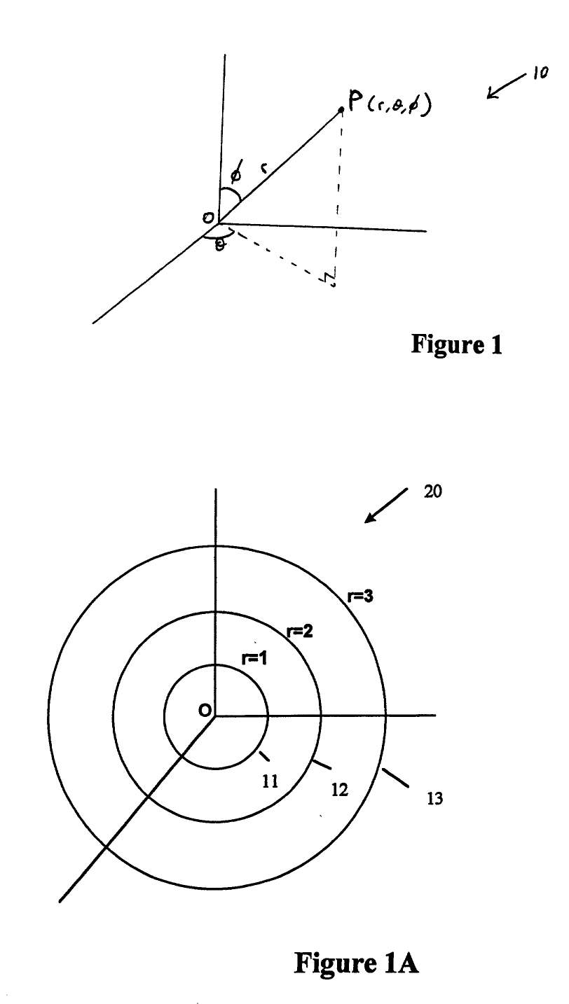

FIG. 1 shows a known system of polar co-ordinates 10, defining an origin O such that any point in space P can be defined relative to the origin O by the use of three parameters (r,θ,φ), where r is a radial distance of the point P from the origin O, θ is a rotational angle subtended by the point P respective to a horizontal axis and φ is an angle subtended by the point P respective to a vertical axis. The angles θ and φ are usually defined in radians as a fraction of π, where π radians equates to 180 degrees.

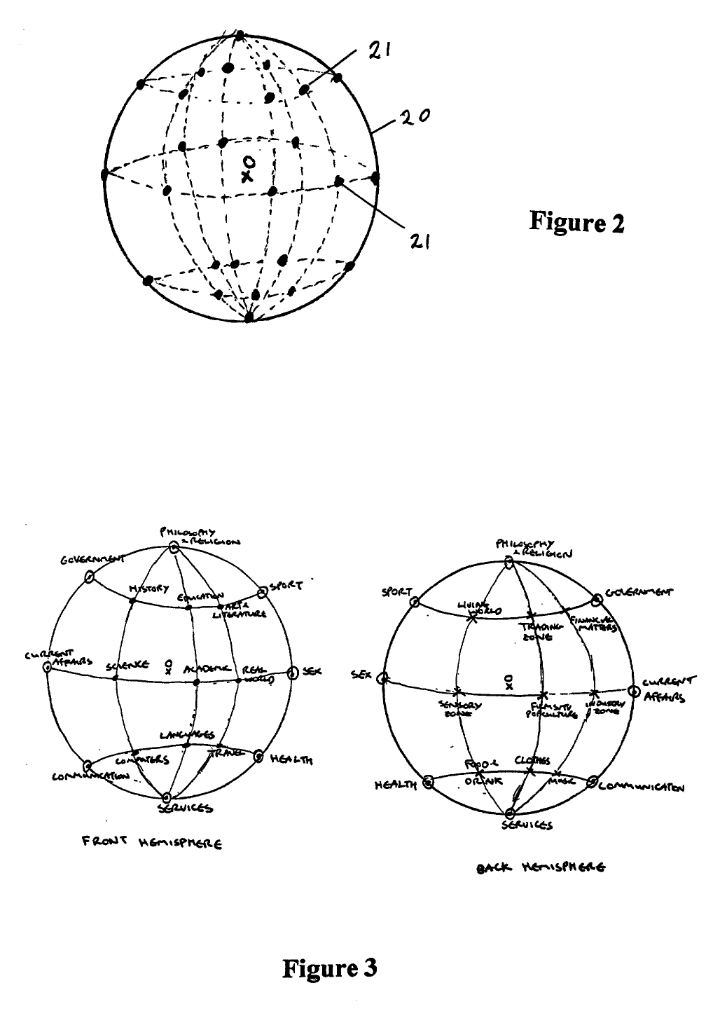

An embodiment of the invention uses such a system of polar co-ordinates 10 for indexing pages on the World Wide Web. This method of indexing may exist alongside the existing method of URLs and IP addresses. Using the invention, a specific web page is defined to have specific spherical co-ordinates in addition to its standard domain name URL and server IP address. The classification can thereby be visualised by displaying an apparently tangible sphere 20 (see FIG. 2) with web sites associated with co-ordinates within this spherical space. That is, all classified web sites are categorised by co-ordinates within the sphere 20 dependent upon the content of the web site. The angular co-ordinates θ and φ of a site are determined by the site's content or subject matter and the radial distance r is determined by the nature or category of the site, for example, whether the site is a commercial vendor, an individual's personal site, or an advertisement.

As shown in FIG. 1A, distinct values of r are defined to divide the sphere 20 into shells 11, 12, 13 dependent on the value of r. Each shell is associated with a different category of web site, for example r=1 is a map and search shell 11 for search sites of any subject, where the subject varies with the angular co-ordinates on the r=1 shell. Shell 12 corresponding to r=2 is, for example, for generic retail sites and shell 13 corresponding to r=3 is, for example, for official reference and information sites, a shell (not shown) corresponding to r=4 is for individual's personal sites and so on with a shell (not shown) corresponding to r=100, for example, being used for advertisement space. In this way the angular co-ordinates θ and φ may be used precisely to define a subject matter with web sites varying along any given angular co-ordinates by the nature or category of the web sites.

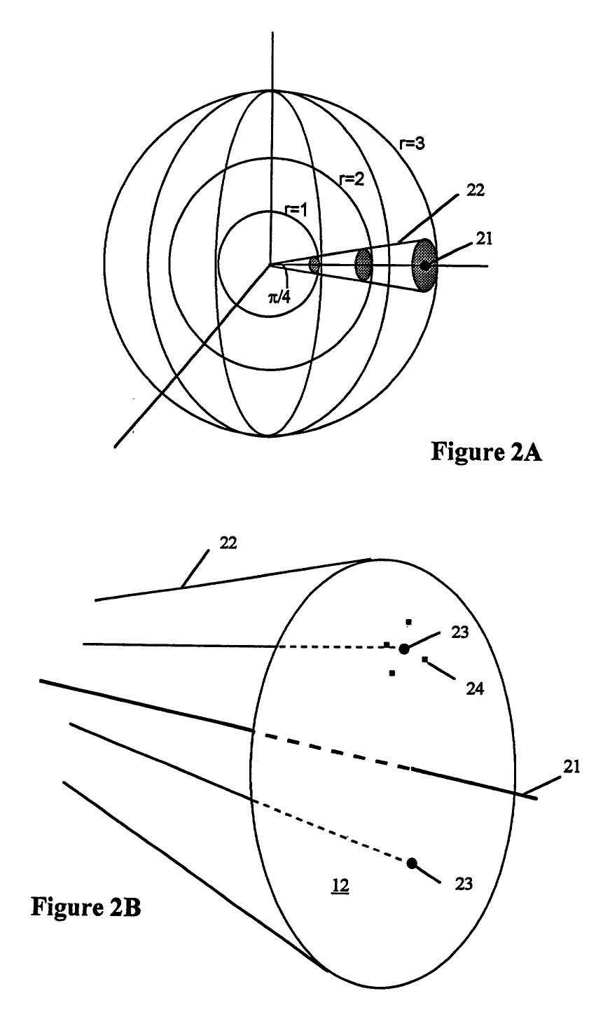

As shown in FIGS. 2 and 2A, the subject space of the sphere 20 is marked by regularly distributed distinct subject radial pillars 21. These radial pillars may, for example, be distributed on the fundamental angles for θ and φ at intervals of π/4. In this way a set of 26 fundamental subject radial pillars can be defined. These subject radial pillars 21 then form axes of cones 22 containing related subject points, the cones having a solid angle of π/4. These subject radial pillars 21 are selected to encompass all aspects of the range of subject areas it is wished to classify. In the case of classifying web sites, the radial pillars would encompass all aspects of subject matter on the Internet. Preferably, subjects are distributed on the radial pillars such that there is a natural progression between neighbouring radial pillars. In this way, related subject matter can be found by small movements around the sphere, which is analogous to rotating the sphere in any direction. Thus any cross-section through the origin of the sphere leads to a distribution around the circumference of the resulting circle which is a natural progression of subject matter. FIG. 3 shows such a possible choice of subject matters for indexing the Internet.

In a different application, different subject radial pillars may be chosen. For example, ten radial pillars could be chosen to represent the top ten hierarchical levels of the Universal Decimal Classification or the Dewey Classification, for indexing the complete field of knowledge, such as in a library collection. Alternatively, radial pillars corresponding to the top hierarchical level of the Library of Congress Classification could be used.

Referring to FIGS. 2A and 2B, a series of overlapping cones 22 are thus defined around each of the radial pillars 21. On each shell 12, 13 within each cone 22 a number of predefined anchoring co-ordinates may be chosen as anchors or pegs 23 relating to a particular subject topic within the subject area of the cone and corresponding to the category of the shell 12. Preferably, as shown in FIG. 2B, a peg referring to a particular subject topic will have the same angular co-ordinates in each shell so that the peg forms a radius of the sphere passing through all the shells. Further sub-pegs 24 may then be defined at co-ordinate points scattered around the pegs 23 relating to sub-topics of the topic of the peg. Preferably, each sub-peg will form a radius of the sphere so that a particular sub topic has the same angular co-ordinates in each shell. For example, within a sports radial pillar 25 (see FIG. 3) would lie different types of sport such as football or rugby, so that football may form one of the pegs and within certain angular co-ordinates from that peg would lie sites relating to a particular football club. The radial co-ordinate or r level would then separate categories of sites selling tickets from an official club site and from an individual fan's personal web site.

It is convenient to define a minimum angular separation for the co-ordinates between adjacent sites. This minimum separation can be reduced as the number of sites classified is increased. If this angular minimum is provisionally set at π×10⁻⁹ there is ample allowance for a large number of web sites to be defined for a shell at any r value. If this minimum angular difference is defined such that π×10⁻⁹ radians=1V, the co-ordinates placing the web sites can be expressed as the number of V they are apart. The web site addresses may then, for example, be stored in a separate table of θ and φ co-ordinates for each value of r, effectively forming a 3D matrix.

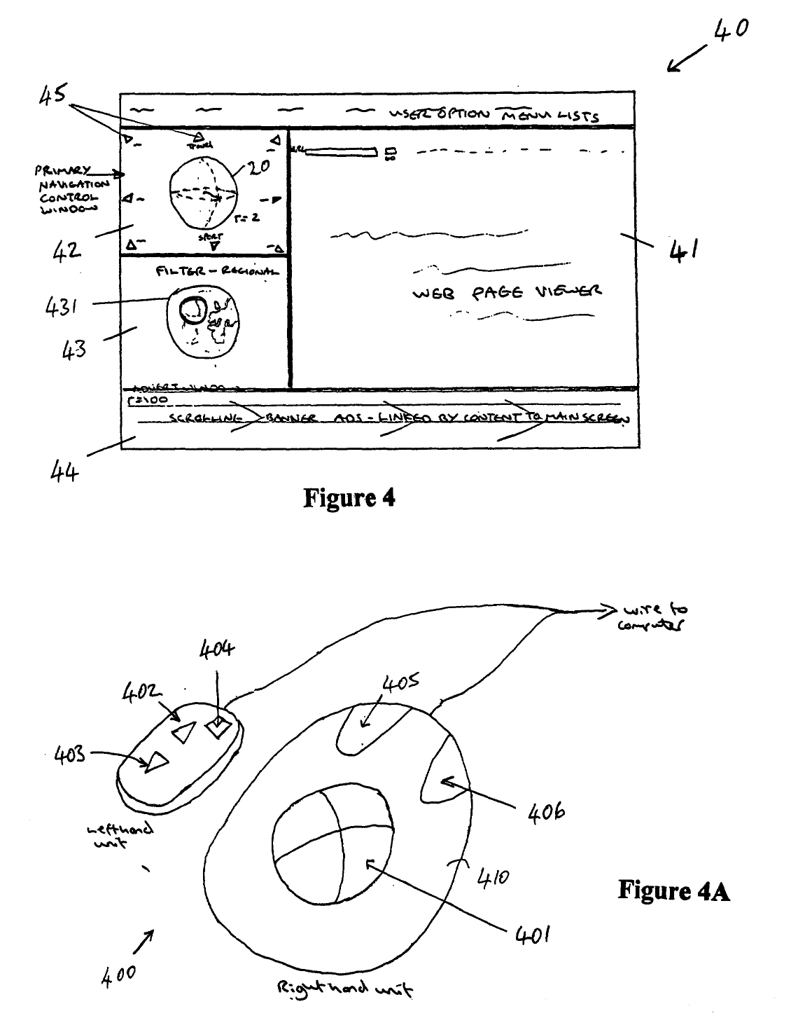

In order to provide the full potential of the visual classification system of the invention it is convenient to employ a new type of web browser window 40 as shown in FIG. 4. The browser display is split into several frames or screens 41, 42, 43, 44. The largest of these screens 41 displays the web site that the user is presently logged into or “visiting”, corresponding to the active page in a known browser. There are two smaller “screens” 42, 43 dedicated to controlling what is displayed in the main screen 41, i.e. they are navigation controls. The first smaller screen 42 displays the user's position within the classification sphere 20 at any time. A sphere is displayed, corresponding to the user's present shell or r value, which sphere can be rotated in any direction by the user in order to browse neighbouring subject matter. Around the edge of the screen are a series of directional arrows 45 showing details of the subject matters that lie in the directions the arrows are pointing, corresponding to neighbouring subject radial pillars 21. Hence a user, guided by the arrows 45, can navigate to a neighbouring site by scrolling the screen 42 and rotating the sphere 20, or by changing the current r value. The browser 40 also has a small screen 44 for displaying advertising material in a manner to be described.

The control screen 42 is navigable by scrolling a standard mouse of a PC in the direction of the arrows 45 on the control screen while the control screen is selected and cursor keys are used to change the value of the r level. However, conveniently a new mouse-type device 400 may be used, as shown in FIG. 4A, specifically designed for use with the browser window 40 of FIG. 4. The input device comprises a first part 410 and a second part 420 for operation by separate hands respectively. The input device 400 has a palm-sized tracker ball 401 in the first part 410. Turning the tracker ball rotates the classification sphere 20 on the control screen 42 and thus moves the user's position within the sphere 20. The first part 410 is also provided with a known first mouse button 405, which is used as a GO button or primary control to select the web page at the tracker ball's current position on the sphere and load it into the main window 41; and with a second known mouse button 406, used as a shortcut button to ‘pop up’ an option list on the screen. The second part of the device 420 is provided with ‘up’ and ‘down’ buttons 402, 403 for changing the shell corresponding to the present value of r displayed. The second part 420 of the input device 400 is also provided with a cursor button 404 to make a cursor appear on the screen so that the tracker ball 401 can be used as a normal mouse, for example to change the screen which is active. A dedicated button (not shown) may be provided to jump to a specific r level, e.g. r=100. The person skilled in the art will understand that this is only one of many possible layouts and arrangements of control devices and that, for example, the controls could alternatively be incorporated in a keyboard.

The browser may be provided with user-defined limits to prevent access to certain groups of web sites. The grouping together of like web sites by angle leads to the development of specific volumes of common interest, and certain of these may be made inaccessible. Thus parental or employer control can be established to prevent a user accessing certain angular co-ordinate ranges.

At any angle selected by the user, advertisements for items related to that subject are posted at the r=100 shell. This provides an intrinsic link between the subject the user is browsing and the advertisements which are displayed on the browser. Thus an advertisement screen 44 can be provided in the browser window 40 that always shows advertisements targeted on the user, based on the web site which is currently active or the user's position in the classification sphere 20. This is a significant improvement on the prior art, in which the majority of banner advertisements displayed on the Internet are unrelated to the subject matter of the active web site.

The invention leads to the development of many areas of like interest, for example to the creation of Trading Districts. Thereby, for example, a forum for trade between companies is created or a foreign exchange area is formed.

The browser may be provided with the capacity, known in the prior art, to filter web sites by country, by selecting sites by domain name suffixes. However, in an embodiment of the browser of the invention, any level of filtering by region or location is possible. This leads to more flexible local searching to a very local level, i.e. to a town or street. This specificity is provided by a second sphere 431 corresponding to a globe of the earth. Thus every web site specialising in local matters is indexed effectively by its longitude and longitude.

Thus web sites are classified in the navigation sphere 20 by their content and are filterable by their physical location or geographical specialisation. The selection of the geographical location can be from a display of a globe 431 in a filter screen 43. Thus it is possible, by an appropriate selection from the globe sphere 431, by rotating the globe 431 in an analogous manner to rotation of the sphere 20, to display on the navigation sphere 20 only those web sites located in or specialising in a particular geographical area. Thus a user can display, for example, only Brazilian web sites or only web sites containing information on the user's own town. It will be understood that for precise locations, a map rather than a globe may be used.

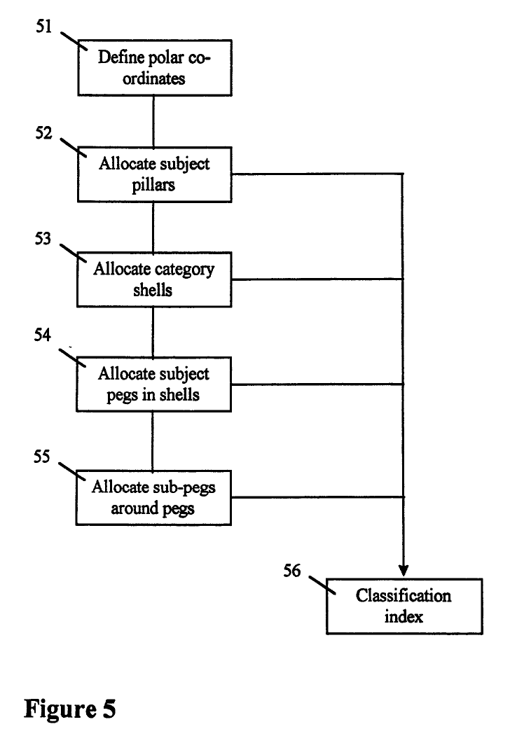

Referring in particular to FIG. 5, in order to set up the classification sphere 20, it is necessary first to define, step 51, polar co-ordinates 10 and to allocate, step 52, subject radial pillars 21 at regular intervals around the co-ordinate system. Category shells 11, 12, 13 are then allocated, step 53, corresponding to integer values of r in a range of, for example r=1 to r=100. Pegs 23 are allocated, step 54, within the shells as required to correspond to topics within the subject area of the subject radial pillar. Finally, sub-pegs 24 are allocated around the pegs corresponding to sub-topics of the respective peg topic. At each of steps 52 to 55, a classification index 56 corresponding to the subject radial pillars, category shells, topic pegs and sub-topic sub-pegs is updated.

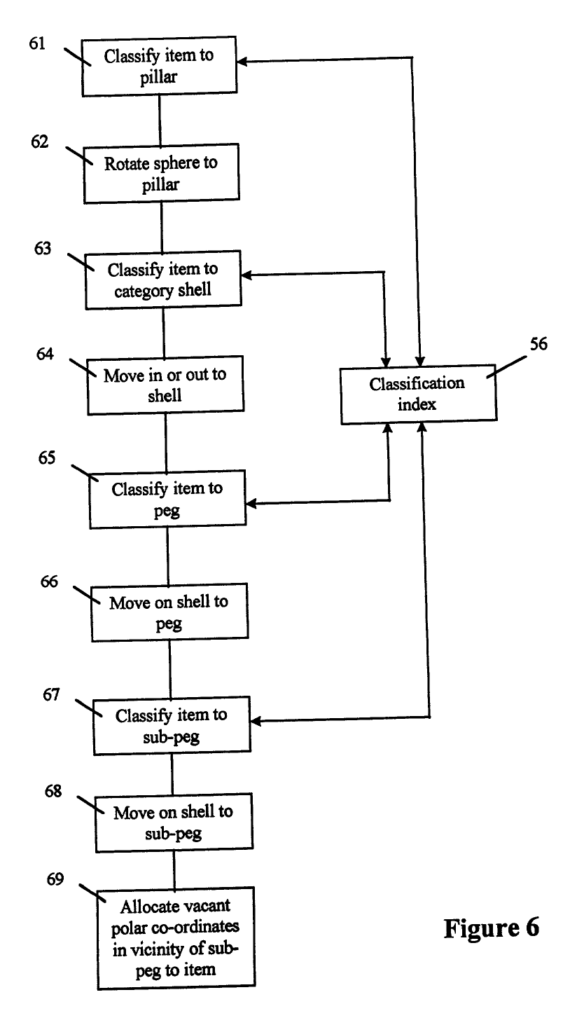

As shown in FIG. 6, and referring to FIGS. 2, 2B and 5, in order to add an information item, such as a new web site, to an existing classification it is first necessary to determine, step 61, to which radial pillar 21 the item is to be classified. This may be facilitated by consulting the index of the classification 56 and then rotating, step 62, the sphere 20 to make that radial pillar visible. It is then necessary to classify, step 63, the item to a category shell 11, 12, 13, which again may be facilitated by the use of the classification index 56. The value of the radial co-ordinate r is changed to move, step 64, through the displayed sphere to display the corresponding shell. It is then determined, step 65, which peg 23 is the most appropriate peg with which to associate the information item or web site and then the sphere is rotated to move, step 66, on the selected shell to the selected peg. Where sub-pegs 24 are used on a shell it is necessary to identify, step 67, with which sub-peg the information item should be associated and to move, step 68, on the shell to that sub-peg. The new information item or web site is then allocated, step 69, to vacant polar co-ordinates in the vicinity of the peg 23 or sub-peg 24. In an embodiment of the invention, the allocation of information items to vacant co-ordinates is performed dynamically, so that the co-ordinates of existing information items are adjusted as each new information item is added to best express the relationships between the items occupying the sites.

It will be understood that the classification of new sites may be performed by the use of crawler programs as known per se together with known automatic classification programs which would classify the contents of web sites according to the classification scheme of the invention.

Information items and web site addresses may also be added to the classification by the owner of the web site on which the classification scheme search engine is resident. However, it is anticipated that other web site owners, subject to suitable controls, will themselves navigate through the classification to add their own web site addresses to appropriate polar co-ordinates within the classification.

With the specificity of the present invention, it will be possible to classify individual pages of web sites, rather than only classifying complete web sites as a single information item.

As with known search engine databases, it will be necessary to review all web sites in the classification scheme from time to time to ensure that only current sites are retained.

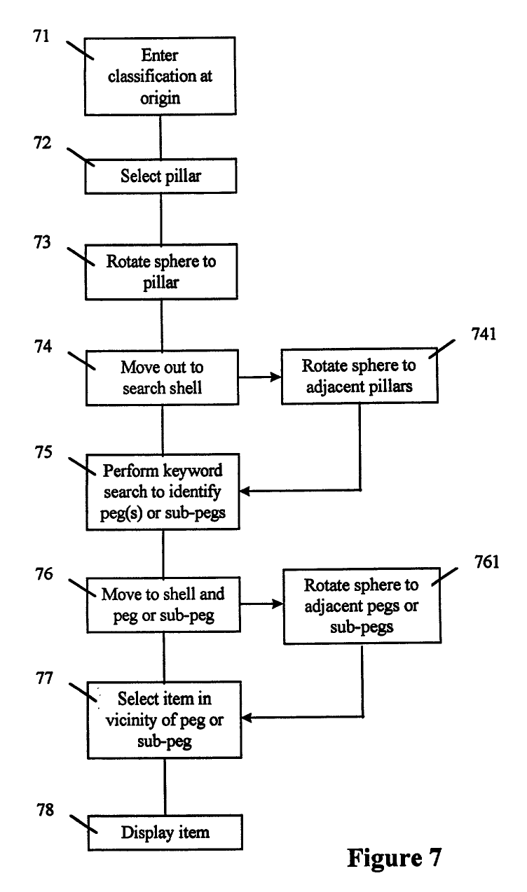

Referring to FIG. 7, in order to locate and retrieve a classified information item of interest, it is necessary to enter, step 71, the classification at the origin O and to select, step 72, a radial pillar 21 of interest. Where there are only a small number of radial pillars, this may be done by the use of a pull-down list in a manner known per se. The sphere 20 is rotated, step 73, to make the selected radial pillar visible. The user then moves, step 74, through the display to the search shell 11 corresponding to r=1, where it is possible, if appropriate, to rotate, step 741, the sphere to adjacent radial pillars until a more appropriate search engine is found. At an appropriate search engine, a keyword search is performed, step 75, for items within that search radial pillar in which the search engine is located, to identify appropriate pegs 23 or sub-pegs 24 within a category or shell of interest. It is then possible to move, step 76, to the appropriate shell and to locate the appropriate peg or sub-peg within that shell; to select, step 77, items of interest within the vicinity of that peg or sub-peg, and to display, step 78, an item of interest in the active screen of the browser window. However, if on moving to the shell and peg or sub-peg no appropriate information items are found, it is possible to rotate, step 761, the sphere to adjacent pegs or sub-pegs which will necessarily be on related topics until items of interest are located. Similarly, it is always possible to browse through the classification sphere or around related items on a shell, without having recourse to a keyword search.

In one embodiment of the invention the information stored at the polar co-ordinates is the domain address of the corresponding web-site or web-page with a brief textual summary. It is this information which is displayed in response to a search. A further selection is then required to load the web-site or web-page into the active window. In a further embodiment of the invention, the web-site or web-page is loaded into the active window immediately as a result of the search, or on moving to the corresponding polar co-ordinates in the classification sphere.

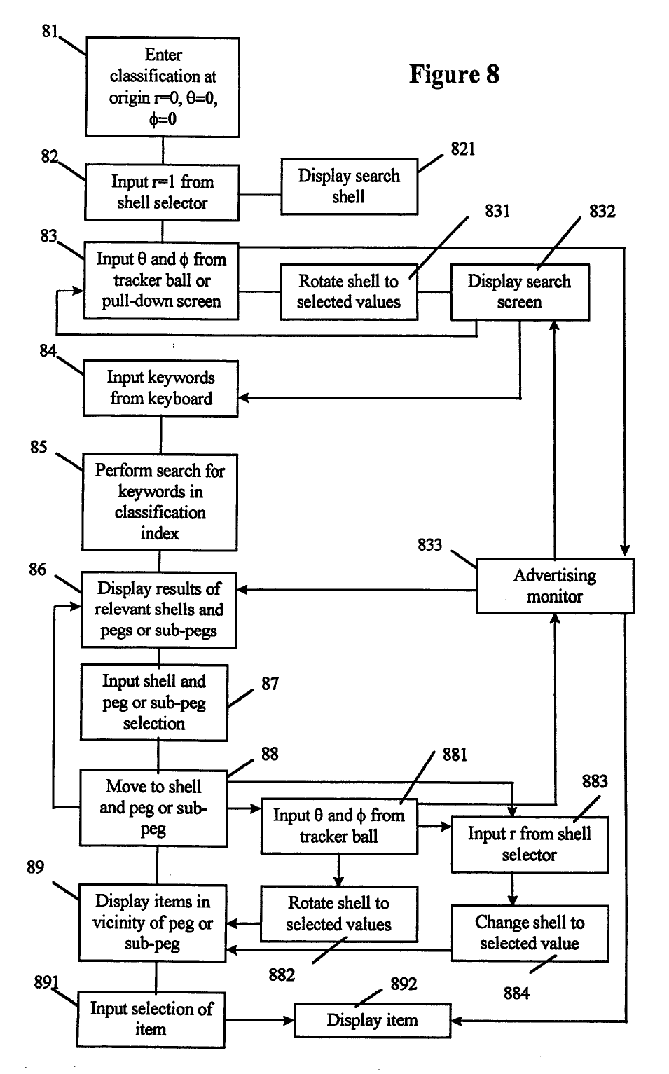

FIG. 8 shows, schematically, program steps corresponding to the user's movement through the sphere 20 in searching for items of interest. Thus, when the user enters the system the co-ordinates are set, step 81, to the origin O (r=0, θ0=0, φ=30). The system may then receive, step 82, an input r=1 from the shell selector input 402, 403 and the search shell 11 is displayed, step 821. Input is then received, step 83, from the tracker ball 401 or pull-down menu of values of θ and φ corresponding to a search radial pillar 21 and the search shell 11 is rotated, step 831, until a search engine corresponding to the input values of θ and φ is displayed, step 832. When the values of θ and φ are entered, step 83, the advertising monitor 833 is updated so that relevant advertisements may be displayed on the search screen. While the search screen is displayed, input keywords are received from a keyboard (not shown), or alternatively, for example, from a speech recognition facility, so that a search may be performed, step 85, in the classification index. On determining matches to the search keywords the results are displayed, step 86, on a results page, as relevant shells 12, 13 and pegs 23 or sub-pegs 24. At the same time, the advertising monitor 833 may display relevant advertisements on the results page. On receipt of input, step 87, of selection of a shell and peg or sub-peg, the display is moved, step 88, to the corresponding shell and peg or sub-peg to display, step 89, items from which items of interest may be selected in the vicinity of the peg or sub-peg. If one of these items is selected, for example by the first mouse input button 405, step 891, the site is displayed, step 892, in the active screen 41 of the browser.

Alternatively, if after moving, step 88, to the shell and peg or sub-peg, no items of interest are discovered, it is possible to input, step 881, new values of θ and φ to rotate, step 882, the shell to find related items associated with neighbouring pegs or sub-pegs, and then to display, step 89, information items in the vicinity of the neighbouring pegs or sub-pegs.

Alternatively, it is possible to input, step 883, new values of the radial coordinate r and to move, step 884, so that a different shell is displayed containing information items distributed around corresponding pegs or sub-pegs.

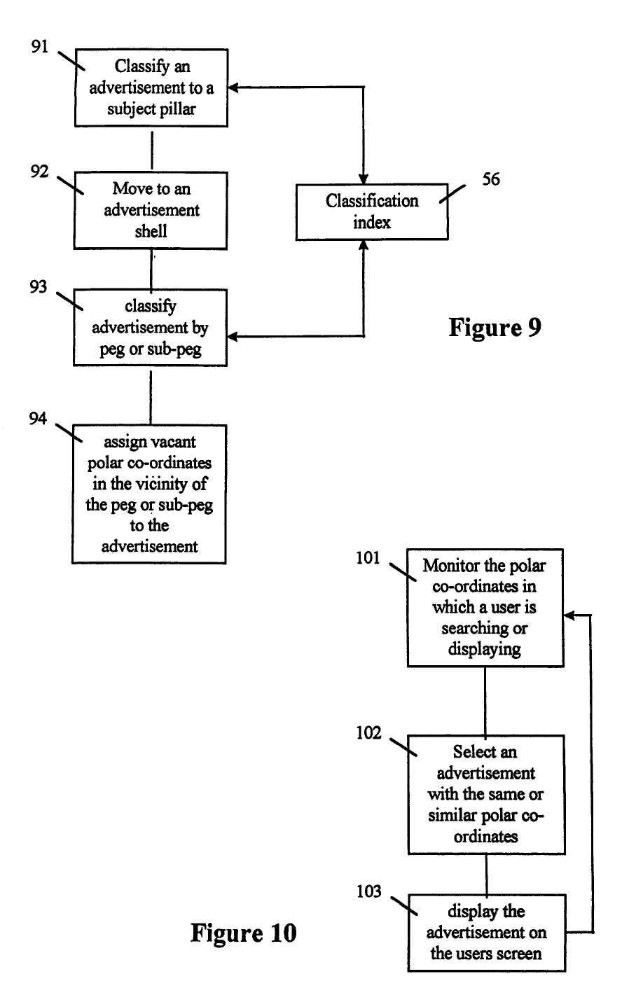

Referring to FIG. 9, new advertisements may be added to the advertisement shell by first classifying, step 91, the advertisement to a subject radial pillar 21 and moving, step 92, to the advertisement shell, classifying, step 93, the advertisement to an appropriate peg 23 or sub-peg 24, possibly using the classification index 56 and assigning, step 94, the advertisement to vacant polar co-ordinates in the vicinity of the peg or sub-peg. This is analogous to adding any other information item to an appropriate shell.

Referring to FIGS. 8 and 10, the advertising monitor 833 at all times monitors, step 101, the angular polar co-ordinates in which the user is searching or displaying so that an advertisement may be selected, step 102, with the same or similar angular polar co-ordinates, and therefore of related subject matter, to that which the user is presently associated with and displaying, step 103, a relevant, targeted advertisement on the user's screen.

Although an embodiment of the invention has been described using polar co-ordinates, it will be appreciated that the three dimensional classification space could be equally well defined by, for example, 3-D Cartesian co-ordinates. Alternatively, a classification space having more than three dimensions could be defined and the co-ordinates stored in tables in the manner described for a polar co-ordinate three dimensional classification space. Using a classification space of more than three dimensions, it will only be possible to display representations in three dimensions simultaneously.

What is claimed is:

1. An organising system for organising information items in a database, the information items having information content within a subject area; the system comprising: geometric means for providing a three dimensional classification space having a co-ordinate origin and providing signals representative thereof to display means whereby the classification space is displayable as a three dimensional rotatable object; input means for associating information items with co-ordinates in the three dimensional classification space; navigating means for searching for information items in the three dimensional classification space; and output means for retrieving at least one of said information items from the three dimensional classification space.

2. A system as claimed in claim 1, wherein the three dimensional classification space is a spherical polar co-ordinate classification space having a spherical co-ordinate origin and the rotatable object is a rotatable sphere.

3. A system as claimed in claim 2, wherein the geometric means includes locating means for associating predetermined subject areas with respective ranges of angles of azimuth and declination relative to the spherical co-ordinate origin to form subject radial pillars.

4. A system as claimed in claim 2, wherein the information items are further associated with respective information categories and the geometric means further comprises categorising means for associating pre-determined information categories with respective ranges of radial distances from the co-ordinate origin to form spherical category shells.

5. A system as claimed in claim 3, wherein the locating means is adapted for allocating predetermined subject topics within a subject radial pillar to respective spaced apart co-ordinates on a shell to form subject pegs.

6. A system as claimed in claim 5, wherein the locating means is further adapted for allocating predetermined subject sub-topics to respective co-ordinates in the vicinity of a related subject peg to form subject sub-pegs.

7. A system as claimed in claim 6, wherein the geometric means further comprises indexing means for updating a classification index with the polar co-ordinate ranges or locations of subject areas, subject categories, subject topics and/or subject sub-topics.

8. A system as claimed in claim 3, wherein the locating means is adapted for allocating an information item according to the subject area of the information item to a corresponding subject radial pillar and assigning polar co-ordinates in the vicinity of the subject radial pillar to the information item.

9. A system as claimed in claim 4, wherein the locating means is further adapted for assigning the information item to a category shell according to the information category of the information item.

10. A system as claimed in claim 5, wherein the locating means is further adapted for allocating the information item according to the subject topic of the information item with polar co-ordinates in the vicinity of the polar co-ordinates of a subject peg corresponding to that subject topic.

11. A system as claimed in claim 6, wherein the locating means is further adapted for allocating information items according to the subject sub-topic of the information item with polar co-ordinates in the vicinity of the polar co-ordinates of a subject sub-peg corresponding to that subject sub-topic.

12. A system as claimed in claim 7, wherein the navigating means is adapted for s electing a subject radial pillar corresponding to the subject area of an information item searched for, preferably by performing a look-up in the classification index, and further comprises rotating means for rotating the sphere as necessary to display contents in the vicinity of the selected subject radial pillar.

13. A system as claimed in claim 5, wherein the navigation means comprises shell display means for displaying within the selected subject radial pillar a search shell having associated search means for performing a search within the subject radial pillar for information items within a required subject category and subject topic, and for displaying a portion of a shell, corresponding to the subject category, containing information items corresponding to the subject topic of the information item searched for in the vicinity of a subject peg corresponding to the subject topic of the information item searched for.

14. A system as claimed in claim 6, wherein the shell display means is adapted for displaying a portion of a shell in the vicinity of a subject sub-peg containing information items corresponding to the sub-topic of the information item searched for.

15. A system as claimed in claim 7, wherein the search means is adapted to search in the classification index for topics and/or sub-topics having associated subject pegs and sub-pegs respectively.

16. A system as claimed in claim 1, wherein the input means is adapted for indexing geographical information associated with the information item and the navigating means is adapted for using geographical information as a search criterion.

17. A system as claimed in claim 16, wherein the input means is adapted for storing a value or range of latitude and longitude associated with the information item and the navigating means is adapted for searching for information items by their associated stored values or ranges of latitude and longitude.

18. A system as claimed in claim 16, wherein the navigating means includes geographical display means for displaying a globe of the world or a map and the navigating means is adapted for selecting on the display of the globe or map the geographical location associated with information items searched for.

19. A method for organising information items in a database, the information items having information content within a subject area; the method comprising the steps of: a) providing geometric means to provide a three dimensional classification space having a co-ordinate origin; b) using the geometric means to provide signals representative of the classification space to display means whereby the classification space is displayed as a rotatable three dimensional object; c) providing and using input means to associate information items with co-ordinates in the three dimensional classification space; d) providing and using navigating means to search for information items in the classification space; and e) providing and using output means to retrieve at least one of said information items from the classification space.

20. A method as claimed in claim 19, wherein step a) includes providing a spherical polar co-ordinate classification space having a spherical co-ordinate origin as the three dimensional classification space and step b) includes displaying a rotatable sphere as the rotable three dimensional object.

21. A method as claimed in claim 20, wherein step a) includes using locating means to associate predetermined subject areas with respective ranges of angles of azimuth and declination relative to the spherical co-ordinate origin to form subject radial pillars.

22. A method as claimed in claim 20, wherein the information items are further associated with respective information categories and step a) includes using categorising means to associate pre-determined information categories with respective ranges of radial distances from the co-ordinate origin to form spherical category shells.

23. A method as claimed in claim 21, wherein step a) includes using the locating means to allocate predetermined subject topics within a subject radial pillar to respective spaced apart co-ordinates on a shell to form subject pegs.

24. A method as claimed in claim 23, wherein step a) includes allocating, using the locating means, predetermined subject sub-topics to respective co-ordinates in the vicinity of a related subject peg to form subject sub-pegs.

25. A method as claimed in claim 24, wherein step a) includes updating a classification index with the polar co-ordinate ranges or locations of subject areas, subject categories, subject topics and/or subject sub-topics.

26. A method as claimed in claim 21, wherein step c) includes using the locating means to allocate an information item, according to the subject area of the information item, to a corresponding subject radial pillar and assigning polar co-ordinates within the subject radial pillar to the information item.

27. A method as claimed in claim 22, wherein step c) further includes using the locating means to assign the information item to a category shell, according to the information category of the information item.

28. A method as claimed in claim 23, wherein step c) further includes using the locating means to allocate the information item, according to the subject topic of the information item, polar co-ordinates in the vicinity of the polar co-ordinates of a subject peg corresponding to that subject topic.

29. A method as claimed in claim 24, wherein step c) further includes using the locating means to allocate the information item, according to the subject sub-topic of the information item, polar co-ordinates in the vicinity of the polar co-ordinates of a subject sub-peg corresponding to that subject sub-topic.

30. A method as claimed in claim 25, wherein step d) further includes using the navigating means to select a subject radial pillar, corresponding to the subject area of an information item searched for, preferably by performing a look-up in the classification index, and further includes rotating the sphere as necessary to display contents in the vicinity of the selected subject radial pillar.

31. A method as claimed in claim 23, wherein step d) further includes using shell display means to display, within the selected subject radial pillar, a search shell having associated search means; performing a search within the subject radial pillar for information items within a required subject category and subject topic; and displaying a portion of a shell, corresponding to the subject category, containing information items corresponding to the subject topic of the information item searched for in the vicinity of a subject peg corresponding to the subject topic of the information item searched for.

32. A method as claimed in claim 29, wherein step d) includes using the shell display means to display a portion of a shell in the vicinity of a subject sub-peg containing information items corresponding to the sub-topic of the information item searched for.

33. A method as claimed in claim 29, wherein step d) includes using the search means to search in the classification index for topics and/or sub-topics having associated subject pegs and sub-pegs respectively.

34. A method as claimed in claim 19, wherein step c) includes using the input means to index geographical information associated with the information item and step d) includes using geographical information as a search criterion.

35. A method as claimed in claim 34, wherein step c) includes using the input means to store a value or range of latitude and longitude associated with the information item and step d) includes using the navigating means to search for information items by their associated stored values or ranges of latitude and longitude.

36. An input device for use in the above method, the input device having means for generating a signal for rotating the rotatable sphere.

37. An input device as claimed in claim 36, wherein the signal generating means is a tracker ball.

38. An input device as claimed in claim 36, wherein the input device also includes selection means for selecting an information category.

39. An input device as claimed in claim 36, wherein the input device further includes cursor control means and switching means for switching the input device between navigation operations according to the present invention and cursor control operations.

40. A computer program comprising program code means for performing all the steps of the above method when the program is run on a computer.

41. A computer program as claimed in claim 40, wherein the computer program is embodied on a computer-readable medium.

42. A computer program product comprising program code means stored in a computer-readable medium for performing the method of claim 19 when that program product is run on a computer.
